(19) United States
(12) Patent Application Publication
(10) Pub. No.: US 2004/0216628 A1
(43) Pub. Date: Nov. 4, 2004

(54) Dual-speed drive mechanism

(76) Inventors: Michael Nordlund, Singapore (SG); Manish Agarwal, Singapore (SG)

Correspondence Address: HEWLETT-PACKARD COMPANY, Intellectual Property Administration, P.O. Box 272400, Fort Collins, CO, 80527-2400, US

(21) Appl. No.: 10/821,599

(22) Filed: Apr. 8, 2004

(30) Foreign Application Priority Data
Apr. 30, 2003 (SG) 200302490-8

(51) Int. Cl. B41F 13/24

(52) U.S. Cl. 101/231

(57) ABSTRACT

A dual-speed printer drive mechanism is disclosed. The drive mechanism includes a drive motor, a drive roller for feeding a media sheet toward and through a printing area and a drive transmission for coupling the drive roller to the drive motor for turning the drive roller with different gear reduction ratios. The drive mechanism further includes a gear reduction ratio selector disposed in the drive transmission for selectively turning the drive roller at a first gear reduction ratio for feeding the media sheet to the printing area, and for selectively turning the drive roller at a second gear reduction ratio for feeding the media sheet with precision for image printing while in the printing area.

### FIELD OF THE INVENTION

The present invention relates generally to motor drive mechanisms, and more particularly to printer drive mechanism having a dual speed drive mechanism.

### BACKGROUND OF THE INVENTION

Conventional drive mechanisms of laser and inkjet printers, faxes, and copiers handle media sheets using a single gear reduction ratio. The gear reduction ratio chosen typically represents a compromise between high printing throughput and torque requirements of the printing device. A high gear reduction ratio provides high torque but requires the motor to operate at a high speed. This tends to result in loss of movement accuracy. A low reduction ratio provides accurate control at a slower speed. This increases the load on the motor and generally results in a large motor requirement. However, large motor has adverse effects on its highest speed achievable, size, and rotor inertia. Thus, a good balance is needed between high speed, high torque and high accuracy.

Existing drive mechanisms utilize a closed loop feedback system that employs an optical disc encoder to track the rotational position of the motor of the drive mechanism. Although this is a cheap and simple approach, the limitation lies in the technical challenges of increasing the optical disc encoder resolution beyond 200 line per inch (lpi) at any given encoder disk diameter, in order to provide increased media sheet feeding accuracy. As an alternative to increasing the encoder resolution, the encoder disc may be correspondingly larger in diameter to increase the effective diameter ratio between the encoder disk and the paper drive roller. The larger the ratio, the higher the resolution at the paper drive roller, for the same given encoder disk. However, the enlargement of the encoder disc has the undesirable impact on the design and overall footprint of the printing device. For instance, a disk with 200 lpi and a 3:1 ratio to the paper drive roller provides a 600 lpi resolution at the paper drive roller. The same disk when used in a 4:1 ratio provides a 800 lpi resolution at the paper drive roller.

A further limitation of existing drive mechanisms is associated with gear backlash. The accumulative error due to gear backlash may be reduced by reducing the number of gears in the transmission of the drive mechanism. However, this requires an increase in the torque handling ability of the motor, because of the larger reflected torque of the load on the motor. For instance, a load of 200 mNm when reflected onto a motor through a reduction ratio of 10:1 requires the motor to support 20 mNm, which is 200/10. However, when the ratio is increased to 20:1, the motor requires to support only 10 mNm.

Other limitations of conventional drive mechanisms include gear stress and noise. Conventional spur gear systems have inherently high tooth stress due to the low number of teeth in mesh and the minimal area of force transfer between mating teeth. Additionally, more teeth in mesh and a large area of torque transfer result in increased operation noise.

The ever-increasing demand for printing devices, such as inkjet printers, to provide high printing throughput in addition to providing high quality printing motivates the need to look for an alternative solution for the drive mechanisms of such printing devices.

### SUMMARY OF THE INVENTION

The present invention is directed to a printer drive mechanism. The drive mechanism includes a drive motor, a drive roller for feeding a media sheet toward and through a printing area and a drive transmission for coupling the drive roller to the drive motor for turning the drive roller with different gear reduction ratios. The drive mechanism further includes a gear reduction ratio selector disposed in the drive transmission for selectively turning the drive roller at a first gear reduction ratio for feeding the media sheet to the printing area, and for selectively turning the drive roller at a second gear reduction ratio for feeding the media sheet with precision for image printing while in the printing area.

### BRIEF DESCRIPTION OF THE DRAWINGS

FIG. 1 is a cross sectional diagram of a printer drive mechanism in accordance with an embodiment of the present invention;

FIG. 2 is a cross sectional diagram illustrating in details a printer drive mechanism in accordance with an alternate embodiment of the present invention; and

FIG. 3 illustrates step-by-step the process for advancing a media sheet in accordance with an embodiment of the present invention.

### DETAILED DESCRIPTION OF THE INVENTION

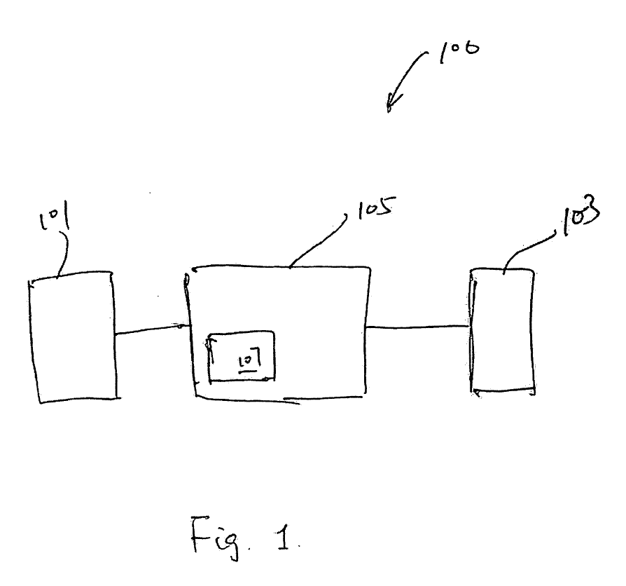

FIG. 1 illustrates a drive mechanism for feeding paper and other print media sheets through a printer, and is referred to herein by the general reference number 100. Such a printer is representative of the many kinds of devices that use drive mechanisms. For example, some fax and copier machines are included in alternative embodiments.

The drive mechanism 100 is mounted to a printer chassis and includes a motor 101 and a driver roller 103 for feeding media sheets towards and through a printing area for image printing. A drive transmission 105 connects the drive roller 103 to the motor 101 for turning the drive roller 103 at different speeds. A gear reduction ratio selector 107 is disposed in the drive transmission 105 for selecting the range of turning speeds of the drive roller 103. The drive roller 103 speed range can be selected at a first low gear reduction ratio for feeding the media sheets quickly to and out of the printing area and a second higher gear reduction ratio for feeding the media sheets with precision for image printing while in the printing area. The first and second range of speeds achieved through first and second gear reduction ratios are hereinafter referred to generally as fast and slow speeds, respectively.

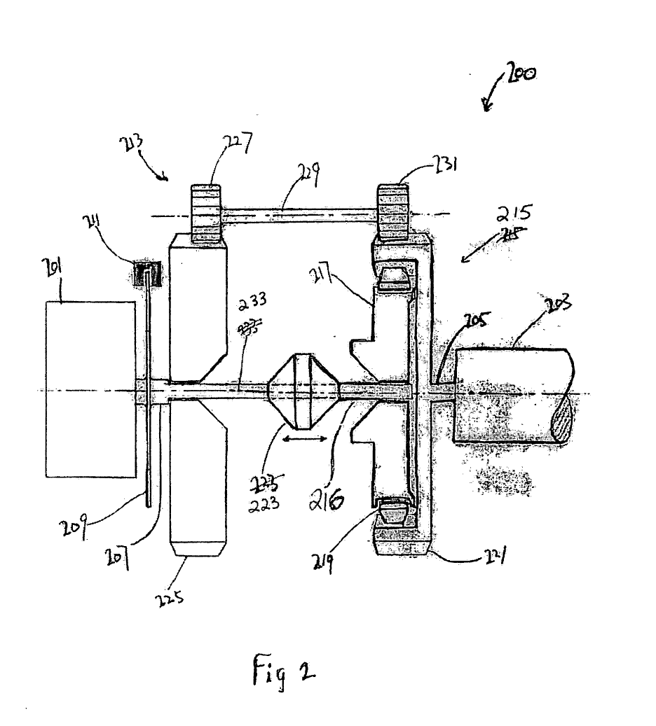

FIG. 2 illustrates in detail another drive mechanism embodiment of the present invention, referred to herein by the general reference number 200. The drive mechanism 200 includes a motor 201, a drive roller 203, and a drive roller shaft 205. A motor shaft 207 is coupled to and rotates together with the motor 201 for providing torque to other parts of the drive mechanism 200. In addition, an encoder disc 209 mounted to the motor shaft 207 works with an optical sensor 211 mounted on the chassis of the printer to detect rotational positions of the motor 201, which correspond to the rotational positions of the drive roller 203. The detected rotational positions of the motor will be fed back to a control mechanism (not shown) for monitoring rotation of the motor 201.

Torque provided by the motor 201 is transmitted through one of a pair of transmission mechanisms 213 and 215 to the drive roller 203. In an embodiment, the pair of transmission mechanisms 213 and 215 include a low-reduction gear train 213 and a harmonic drive 215, respectively.

The harmonic drive 215 assures high positional/rotational accuracy and provides a high-reduction ratio of, for example, 1/30-1/320. Therefore, when power is transmitted from the motor 201 through the harmonic drive 215 to the drive roller 203, the drive roller 203 rotates at a relatively low speed and provides a highly precise paper advance. The harmonic drive 215 includes a wave generator 217, a flexspline 219 and a circular spline 221 whereby the three components are mounted coaxially.

The wave generator 217 is rotatable about the motor shaft 207 and is engagable with a clutch gear 223 for receiving torque therefrom. The wave generator 217 typically has bearings, such as ball bearings, built into the outer circumference of an elliptical cam. An inner raceway of bearings is fixed to the elliptical cam, and an outer raceway is elastically deformed by pressure applied by the bearings. The wave generator 217 is coupled to a clutch gear 223 via an input shaft 216, which is effectively one end of the motor shaft 207.

The flexspline 219 includes a thin cup-shaped rim with teeth and is fixed to prevent absolute rotational motion. The flexspline 219 couples the wave generator 217 to the circular spline 221 for providing torque thereto as shown in FIG. 2.

The circular spline 221 is typically a rigid ring and has a plurality of internal and external engaging teeth (not shown). The internal teeth of the circular spline 221 engage the external teeth of the flexspline 219 for receiving torque. The circular spline 221 is rigidly fixed to the drive roller shaft 205 for providing torque to the drive roller 203.

In operation, the flexspline 219 is deflected by the wave generator 217 into an elliptical shape causing the teeth of the flexspline 219 to engage with those of the circular spline 221 at the major axis of the wave generator ellipse while the teeth across the minor axis of the wave generator ellipse are disengaged. When the wave generator 217 is rotated clockwise with the flexspline 219 fixed from rotating, the flexspline 219 is subjected to elastic deformation and its tooth engagement position moves by turning relative to the circular spline 221. For example, if the circular spline 221 has two more teeth than the flexspline 219, when the wave generator 217 rotates 180 degrees clockwise, the flexspline 219 tends to want to move counterclockwise by one tooth relative to the circular spline 221. However, since the flexspline 219 is restricted from rotating, the circular spline 221 is forced to rotate in a clockwise direction. Furthermore, when the wave generator 217 rotates one revolution clockwise (360 degrees), the flexspline 219 tends to want to move counterclockwise by two teeth relative to the circular spline 221 because, in this example, the flexspline 219 has two fewer teeth than the circular spline 221. Since the flexspline 219 is restricted from rotating, the circular spline 221 is forced to rotate in a clockwise direction, and in general terms, this movement is treated as output torque.

The low-reduction gear train 213 of the transmission mechanism 213 provides a relatively low-reduction ratio of, for example, 1:4 to 1:10. Therefore, when torque is transmitted from the motor 201 through the low-reduction gear train 213 to the drive roller 103, the drive roller 203 rotates at a relatively fast speed. The low-reduction gear train 213 includes a high speed advance gear 225 rotatable about the motor shaft 207 and is engagable with the clutch gear 223 for receiving torque from the motor 201. Torque is then transmitted through a first connecting gear 227, a gear shaft 229 and a second connecting gear 231 engaged with the external teeth of the circular spline 221 of the harmonic drive 215. In this way, torque is transmitted to the drive roller 203 through the circular spline 221 and the drive roller shaft 205.

Therefore, the exemplary drive mechanism 200 can operate in one of two drive modes: a first mode in which the motor 201 drives the drive roller 203 through the low-reduction gear train 213 and the drive roller 203 feeds the media sheet at a relatively high speed; and a second mode in which the motor 201 drives the drive roller 203 through the harmonic drive 215, and the drive roller 203 feeds the media sheet at a relatively low speed with a highly precise paper feeding.

Selection of the drive mode is achieved through the clutch gear 223. The clutch gear 223 is located between the low-reduction gear train 213 and the harmonic drive 215 in the drive mechanism 200, and selectively engages one of the transmission mechanisms 213 and 215 with the motor shaft 207 such that torque can be transmitted to the drive roller 203 through the selected transmission mechanism. The clutch gear 223 is mounted to and rotates together with the motor shaft 207. Furthermore, the clutch gear 223 is movable axially along an axis 233 of the motor shaft 207 between a first and a second position (not shown), where the clutch gear 223 engages one of the transmission mechanisms 213 and 215, respectively. By controlling the selective engagement of the clutch gear 223 with the transmission mechanisms 213 and 215, the exemplary drive mechanism 200 operates in one of the drive modes accordingly.

The positioning of the keyed clutch gear 223 may be obtained through various means, including solenoid control or carriage motion activation. The position the clutch gear 223 takes is determined by the printer control system (not shown) which is aware of the image data content and decides whether fast speed or low speed (high precision) media sheet feeding should be selected. For example, page load, page eject, or blank space feeding sequences prefer a fast speed media sheet feeding, while photo image printing refers a low speed and high precision media sheet feeding. In an embodiment, the exemplary drive mechanism 200 operates in a first mode when advancing the media sheet to the print zone and when printing is completed and in a second mode during printing.

To engage the first mode (i.e. for the combination of a high speed and low precision linefeed), the clutch gear 223 is moved towards the motor 201 to engage the high speed advance gear 225. This directly transmits the torque from the motor 201 to the high speed advance gear 225. It should be noted that both the encoder disk 209 and the clutch gear 223 are keyed to the motor shaft 207 to ensure direct motion of the motor 201 to the high speed advance gear 225. The torque is then transferred from the high speed advance gear 225 to the first connecting gear 227 and to the second connecting gear 229 via the gear shaft 229 as shown in FIG. 2. Torque is then transmitted directly from the second connecting gear 231 (which engage with the external teeth of the circular spline 221) to the circular spline 221. Finally, as the circular spline 221 is rigidly connected to the drive roller shaft 205, torque transmission from the motor 201 to the drive roller 203 is acheived.

To engage the second mode (i.e. for the combination of a low speed and high precision linefeed), the clutch gear 223 is moved towards the drive roller 203 to engage the wave generator 217. Wrapped freely around the circumference of the wave generator 217 is the flexspline 219 having a flexible band with teeth (not shown) engaging the internal teeth (not shown) of the circular spline 221. The teeth of the flexspline 219 engage the internal teeth of the circular spline 221 at two points, which coincide with two opposite intersections of the major axis of the elliptical cam of the wave generator 217 and the pitch diameter of the gear engagement. It should be noted that the number of teeth of the flexspline 219 is lesser than the number of internal teeth of the circular spline 221 and, in this mode, the flexspline 219 is restrained from axial rotation. Therefore, each rotation of the wave generator 217 translates into a rotation of the circular spline 221 in the same direction.

The angle of the rotation is dictated by the difference in the number of teeth of the circular spline 221 and the flexspline 219. Overall, with the clutch gear 223 keyed to the motor shaft 207, torque from the motor 201 is transmitted directly to the wave generator 217, wherein the rotational movement of the wave generator 217 provides torque to the circular spline 221 through the large gear ratio reduction between the flexspline 219 and the circular spline 221. As the circular spline 221 is rigidly connected to the drive roller shaft 205, torque transmission from the motor 201 to the drive roller 203 is achieved.

An advantage of the harmonic drive 215 is that it is capable of providing high positional/rotational precision due to the many built-in simultaneous-mating teeth. These teeth mate with one another in two symmetrical positions at 180 degrees. This arrangement results in minimizing tooth pitch errors and accumulated pitch errors on rotational accuracy to ensure high positional/rotational precision. Moreover, by using the harmonic drive 215, the drive mechanism 200 achieves the desired highly precise paper feeding without demanding extra requirements on the encoder disc 209.

Another advantage of the harmonic drive 215 is that it has very little gear backlash. Therefore, detection of the drive roller 203 rotational positions can be performed by detecting the rotational positions of the motor 201 using the encoder disc 209 coupled to the motor shaft 207. Since the drive roller 203 rotates at a slower speed than the rotation of the motor 201 when the drive mechanism 200 operates in the second mode, the encoder disc 209 can have a relatively small size when compared to a conventional drive mechanism.

A further advantage of the harmonic drive 215 is that all of its three basic components (i.e. the wave generator 217, the flexspline 219, and the circular spline 221) are co-axially aligned when assembled. Thus, the harmonic drive 215 can be easily built into component-assembled products allowing for simple configurations. This means that transmissions in printer mechanisms can be made smaller in size and lighter in weight because the harmonic drive 215 provides the same levels of torque and speed reduction ratios as conventional gearing mechanisms despite the fact that it is approximately ⅓ the size of conventional products in terms of capacity and at least ½ the weight.

It is also noted that the harmonic drive 215 provides a high level of operational efficiency thus allowing for the down sizing of the motor 201. The benefit arises from the inherent nature of the harmonic drive 215 whereby the number of simultaneously mating teeth in the flexspline 219 accounts for some 30% of the total number of teeth, and these teeth come into contact with one another face to face. Thus, every tooth is subjected to minimal force while providing maximum torque. Further, the mating portion of each tooth is subjected to very little sliding motion. Accordingly, motion loss due to friction is reduced substantially and quiet and vibration-free operations are possible.

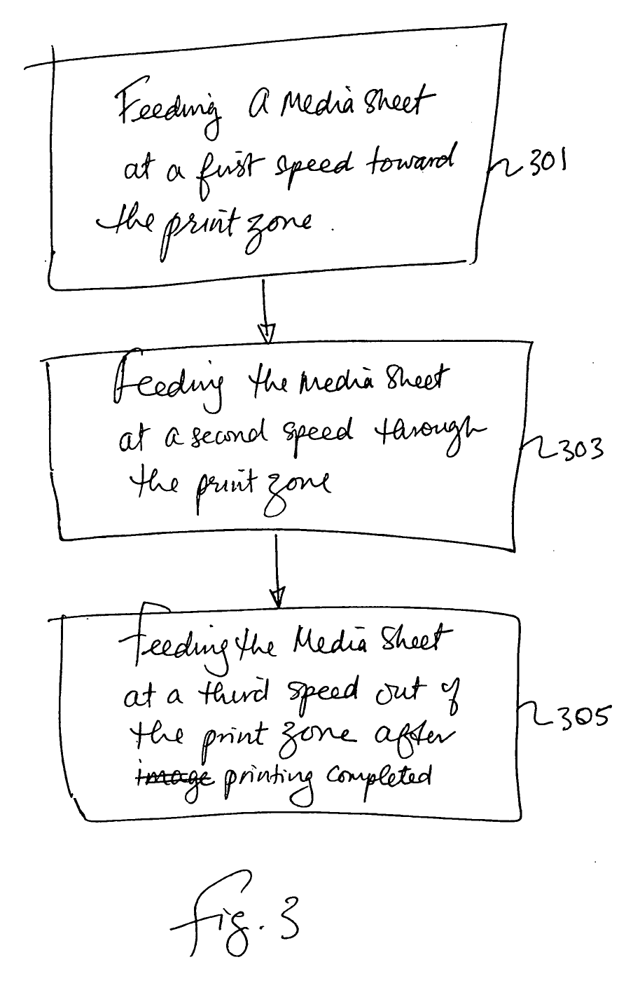

FIG. 3 shows a high-level flowchart of a process for feeding a media sheet in a printer. As shown in FIG. 3, in a step 301, the media sheet is firstly advanced at a first speed towards the print zone before it reaches the print zone. In a step 303, when the media sheet is in the print zone for image printing, the media sheet is fed at a second speed through the print zone. After the image printing is completed in the step 303, the media sheet is fed at a third speed out of the print zone to the output area of the printer in a step 305. In an embodiment, the first and third speeds are equal but faster than the second speed. The first and third speeds can be faster because high feeding accuracy is not needed during non-printing advancement. The second speed is to provide accurate feeding for superior printing quality. In another embodiment, in the step 305, the third speed can be different from the first speed. As described in the foregoing, the exemplary drive mechanism 200 achieves highly precise paper feeding during the printing while providing overall high printing throughput.

While embodiments of the present invention has been shown and described, it should be understood that other modifications, substitutions and alternatives are apparent to one of ordinary skill in the art. Such modifications, substitutions and alternatives can be made without departing from the spirit and scope of the invention. Accordingly, it is intended that the appended claims be interpreted as covering all alterations and modifications as fall within the spirit and scope of the invention.

What is claimed is:

1. A printer drive mechanism, comprising:
a drive motor;
a drive roller for feeding a media sheet towards and through an image printing area;
a drive transmission for coupling to the drive roller to the drive motor for turning the drive roller at different speeds; and
a speed selector disposed in the drive transmission for selecting the range of turning speeds of the drive roller at a first speed for feeding the media sheet to the printing area and at a second speed for feeding the media sheet with precision for image printing while in the printing area.

2. The drive mechanism of claim 1, wherein the speed selector comprises a clutch gear coupled to the motor wherein the clutch gear is movable between a first and a second position, wherein the first and second positions respectively correspond to the first and second speed.

3. The drive mechanism of claim 1, wherein the first speed is faster than the second speed.

4. The drive mechanism of claim 1, wherein the first speed is characterized by rapid media sheet feeding with less precision and the second speed is characterized by precision media sheet feeding at a speed slower than the first speed.

5. The drive mechanism of claim 1, wherein the drive transmission comprises a low-reduction and a high-reduction mechanism, and the speed selector selectively engages the drive roller with the drive motor through one of the low-reduction and high-reduction transmission mechanisms such that the drive roller feeds the media sheet at the first or second speed respectively.

6. The drive mechanism of claim 5, wherein the high-reduction transmission mechanism is a harmonic drive for providing a precise line feed characteristic to the drive roller.

7. The drive mechanism of claim 6, further comprising an encoder disk coupled to the drive motor for detecting rotational positions of the drive roller through rotational positions of the drive motor.

8. A printer drive mechanism, comprising:
a drive motor;
a drive roller for feeding a media sheet towards and through an image printing area;
a low-reduction gear train coupled to the drive roller and selectively engagable with the drive motor for selectively coupling the drive roller to the drive motor and for turning the drive roller at a first speed;
a harmonic drive coupled to the drive roller and selectively engagable with the drive motor for selectively coupling the drive roller to the motor and for turning the drive roller at a second speed; and
a clutch gear movable between a first and a second position for selectively engaging one of the low-reduction gear train and the harmonic drive with the drive motor.

9. The drive mechanism of claim 8, wherein the first speed is faster than the second speed.

10. A process for feeding a media sheet in a printer, comprising the steps of:
feeding the media sheet at a first speed towards a print zone in the printer before the media sheet reaches the print zone; and
feeding the media sheet at a second speed through the print zone where images are printed onto the media sheet.

11. The process of claim 10, wherein the first speed is higher than the second speed.

12. The process of claim 10, further comprising the step of feeding the media sheet out of the print zone to an output area at a third speed.

13. The process of claim 12, wherein the first and second speed is equal.

14. A printer having a drive mechanism for handling a media sheet, the drive mechanism comprising:
a drive motor;
a drive roller for feeding a media sheet towards and through an image printing area;
a low-reduction gear train coupled to the drive roller and selectively engagable with the drive motor for selectively coupling the drive roller to the drive motor and for turning the drive roller at a first speed;
a harmonic drive coupled to the drive roller and selectively engagable with the drive motor for selectively coupling the drive roller to the motor and for turning the drive roller at a second speed; and
a clutch gear movable between a first and a second position for selectively engaging one of the low-reduction gear train and the harmonic drive with the drive motor.
